(19) United States
(12) Patent Application Publication
(10) Pub. No.: US 2025/0372992 A1
(43) Pub. Date: Dec. 4, 2025

(54) WET-TYPE OUTDOOR CABLE TERMINATION

(71) Applicant: Prysmian S.p.A., Milano (IT)

(72) Inventors: Paolo Boffi, Lecco (IT); Andrea Ferti, Monza (IT)

(21) Appl. No.: 19/217,544

(22) Filed: May 23, 2025

(30) Foreign Application Priority Data
May 30, 2024 (IT) 102024000012337

(51) Int. Cl. H02G 15/064; H02G 1/14

(52) U.S. Cl. CPC H02G 15/064; H02G 1/14

(57) ABSTRACT

A wet-type outdoor cable termination can include a tubular insulation body extending along a longitudinal axis, wherein the tubular insulation body includes a main chamber configured to be at least partially filled with an electrically insulating fluid, a pass-through bottom plate mechanically connected to a lower end of the tubular insulation body, a stress cone housed within the tubular insulation body, wherein the stress cone is configured to be fitted to an end portion of an electric cable, and a segregating tube coaxially extending within the tubular insulation body between the stress cone and the pass-through bottom plate, wherein segregating tube is surrounding and contacting at least a lower portion of the stress cone and defining a safety chamber configured to partially house the end portion of the electric cable, wherein the segregating tube includes at least one corrugated portion configured to make the segregating tube flexible.

### CROSS-REFERENCE TO RELATED APPLICATIONS

This application claims priority to and the benefit of Italian Patent Application No. 102024000012337 filed on May 30, 2024, the entire contents of which are incorporated herein by reference.

### TECHNICAL FIELD

The present disclosure relates to a wet-type outdoor termination for electrical cables.

### BACKGROUND

Typically, a HV electrical cable includes one cable core including one or more conductors covered by an insulation system. The insulation system is sequentially formed by an inner semiconductive layer, an insulating layer, an outer semiconductive layer. The insulation system is generally sequentially surrounded by a metal screen and an outer protective jacket. Before assembly operations between the termination and the cable, an end portion of the cable is subjected to cut and peeling procedures so as to present, one adjacent to the other, a first length of exposed outer semiconductive layer, a second length of exposed insulating layer, and a third length of exposed electric conductor.

A wet-type cable termination generally includes a tubular insulating (either polymeric or ceramic) body and an electric field control element, commonly named "stress cone", both adapted to house the cable end portion, the stress cone being arranged in a radially inner position with respect to the tubular insulating body. The stress cone includes a semiconductive portion, and mitigates and controls the electric stress distribution where the outer semiconductive layer of the cable is interrupted.

The space between the stress cone and the tubular insulating body is filled with an electrically insulating fluid, typically a dielectric oil, such as silicone, or a gas, such as sulfur hexafluoride (SF6).

In order to protect the cable outer semiconductive layer and, in some instance, the stress cone semiconductive portion from any possible chemical interaction with the insulating fluid, a segregating equipment can be installed around and in contact with the lower portion of the stress cone to cover the above-mentioned critical part(s). Possible solutions already available as segregating equipment include rigid (e.g. metallic or polymeric) segregating tubes, and/or tapes or gaskets.

For example, US patent 8,525,025 B2 relates to a direct current cable termination apparatus including a tubular partition that is positioned around the terminal portion of the cable and separates the space into a first chamber and a second chamber. The partition may be made of an electrically insulating and polymer-containing material, for example glass fiber- reinforced epoxy. The first chamber is filled with an electrically insulating first fluid. The conductive shield terminates inside the second chamber, and the electric field control member is located within the second chamber. The partition is physically connected to the electric field control member. The partition has a periphery which may be electrically conductive.

PCT patent application WO 2023/190975 A1 relates to a power cable termination structure where an insulating fluid is applied to cover the exposed area of the conductor and outer semiconductive layer. An insulator tube contains the terminal end portion of the power cable and is filled with an insulating fluid. A metal tube is configured to be able to slide relative to a lower flange portion in response to expansion and contraction of the power cable. The power cable is inserted into the metal tube, and the upper end of the metal tube and the peeled portion of the outer semiconductive layer of the power cable are sealed by a sealing structure. The seal structure prevents the insulating fluid from penetrating into the inner part of the metal tube. The sealing structure is made of, for example, self-bonding tape and heat shrink tubing.

Chinese utility model patent CN 209267137 U relates to a cable terminal. At least one protective layer covering the cable is provided between the semiconducting part and the flange collar. A shrink tube capable of shrinking and sealingly covering the protective layer, the semiconducting part, and the flange collar is also provided between the semiconducting part and the flange collar. The shrink tube is a flexible tube that can automatically shrink under specified conditions and is generally a rubber shrink tube. The protective layer includes a semiconductive tape layer and an insulating layer covering the semiconductive tape layer.

Due to thermal variations occurring during the operative loading cycles, the electrical cable end connected to the termination maybe subjected to axial and radial expansions and contractions, leading to longitudinal and lateral movements, whereas a steady contact between the segregating equipment and the stress cone should be ensured to preserve the sought protection. Rigid tubes require strict rules to be implemented in the installation of the cable, otherwise the contact with the stress cone would be unsteady during the longitudinal and lateral movements of the cable as a consequence of the loading cycles. Besides being uncoupled during thermal cycles, tapes, gaskets, and polymeric portions in general can be deteriorated by the fluid over time, thus losing their protective function.

### SUMMARY

The present disclosure relates to a wet-type outdoor termination for electrical cables, in particular for high voltage (HV) electrical cables. In the present description and in the attached claims, the term "high voltage" is used to refer to a voltage above 30 kV.

According to an embodiment of the present disclosure, a wet-type outdoor termination can include: a tubular insulation body extending along a longitudinal axis between an upper end and a lower end and delimiting a main chamber adapted to be at least partially filled with an electrically insulating fluid; a pass-through bottom plate mechanically connected to the lower end of the tubular insulation body; a stress cone housed within the tubular insulation body, adapted to be fitted to an end portion of an electric cable; and a segregating tube coaxially extending within the tubular insulation body between the stress cone and the pass-through bottom plate, surrounding and contacting at least a lower portion of the stress cone and defining a safety chamber adapted to partially house the end portion of the electric cable, wherein the segregating tube includes at least one corrugated portion making the segregating tube flexible.

In an embodiment, the segregating tube may be made of a material selected from metallic material or of polymeric material or both.

In an embodiment, the segregating tube can be made of a material including at least one metal. The metal of the segregating tube may be amagnetic. A suitable metal for the segregating tube of an embodiment of the present disclosure may be stainless steel.

In an embodiment, the segregating tube can be made of an electrically conductive material.

In an embodiment, the safety chamber can be free from electrically insulating fluid.

In an embodiment, the at least one corrugated portion of the segregating tube can be arranged between two opposite smooth portions formed in a single piece with the corrugated portion.

In an embodiment, the at least one corrugated portion and the smooth portions of the segregating tube may be formed in the same or different material. For example, the at least one corrugated portion and the smooth portions may be both made of a metal but in different alloys. For example, the at least one corrugated portion and the smooth portions may be made of different grades of stainless steel.

In an embodiment, the stress cone can delimit a channel for the fitting of the cable end portion. The stress cone can include a semiconductive portion and an insulating sleeve partially embedding the semiconductive portion. The part of the semiconductive portion embedded in the insulating sleeve can be also called "deflector".

The semiconductive portion of the stress cone can be adapted to be at least partially in direct contact with an outer semiconductive layer of the electric cable end portion. In some embodiments, the semiconductive portion can be fully encircled by the insulating sleeve. In some embodiments, the semiconductive portion can extend out of the insulating sleeve at the lower portion of the stress cone.

The segregating tube may be in direct contact with the insulating sleeve or with the semiconductive portion extending out of the insulating sleeve.

In an embodiment, at an upper end the segregating tube can include a first flange for the mechanical connection to the stress cone, and at a lower end a second flange for the mechanical connection to the pass-through bottom plate.

In an embodiment, the first and/or the second flange may be welded to the smooth portions of the segregating tube.

### BRIEF DESCRIPTION OF THE DRAWINGS

Further characteristics and advantages of example embodiments of the present disclosure can be more apparent from the following description with reference to the enclosed drawings, in which:

FIG. 1 a sectional view, taken along a longitudinal plane, of a wet-type outdoor cable termination according to an embodiment of the present disclosure; and

FIG. 2 is a side view of a segregating tube of a termination according to an embodiment of the present disclosure.

### DETAILED DESCRIPTION OF ILLUSTRATIVE EMBODIMENTS

For the purpose of the present description and of the appended claims, except where otherwise indicated, all numbers expressing amounts, quantities, percentages, and so forth, can be understood as being modified in all instances by the term "about". Also, all ranges can include any combination of the maximum and minimum points disclosed and can include any intermediate ranges therein, which may or may not be specifically enumerated herein.

For the purpose of the present description and of the appended claims, the words "a" or "an" are used to describe elements and components of the present disclosure. This is done merely for convenience and to give a general sense of the present disclosure. In this description and claims should be read to include one or at least one and the singular also can include the plural, unless expressly stated otherwise.

The present disclosure, in at least one of the aforementioned example embodiments, can be implemented according to one or more of the following embodiments, optionally combined together and/or various features of different embodiments can be combined.

In the present description and claims, terms like "upper" and "lower" can be used to indicate positions within the cable termination intended standing vertical, such as in some operating conditions.

An embodiment of the present disclosure can provide a wet-type outdoor cable termination that can allow axial and radial expansions of the electrical cable due to thermal variations occurring during the load cycles thereof, while maintaining at the same time a steady contact between the segregating element and the stress cone of the termination, and thus can avoid insulating fluid leakage.

According to an embodiment of the present disclosure, the Applicant has found that providing a wet-type outdoor termination with a segregating tube having a corrugated central portion, making it flexible in longitudinal and lateral directions, can allow maintaining the quality of protection provided by a rigid segregating tube, without affecting the reliability of the cable termination during its service, in particular by maintaining the contact between the cable and the stress cone during the longitudinal/lateral movements of the cable as a consequence of the loading cycles.

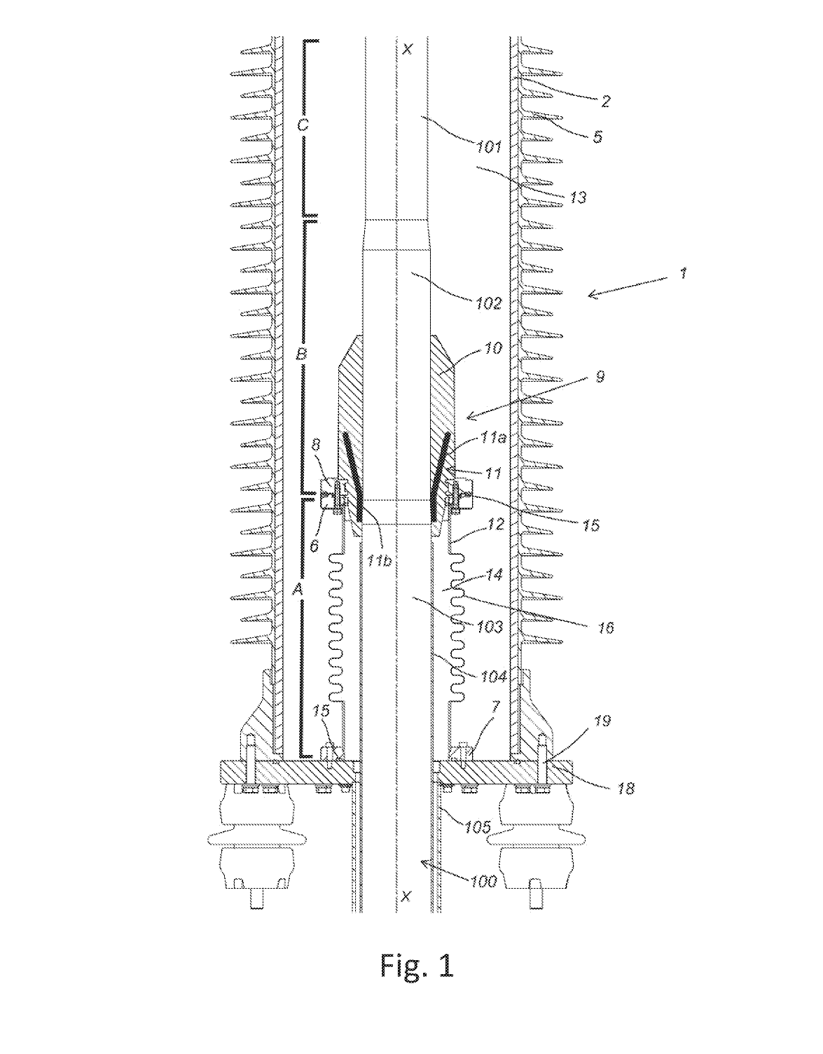

FIG. 1 shows an embodiment of a wet-type high voltage (HV) cable termination 1 and an end portion of a HV power cable 100 housed therein.

The power cable 100 as shown in FIG. 1 can include an electrically conductive core 101 and a cable insulation system surrounding the electrically conductive core 101. The cable insulation system can include a cable inner semiconductive layer (not illustrated) surrounding and in contact with the electrically conductive core 101, a cable insulating layer 102, surrounding and in contact with the inner semiconductive layer, and a cable outer semiconductive layer 103, surrounding and in contact with the insulating layer 102. Around to the outer semiconductive layer 103 a metal screen and an outer protective sheath (both not illustrated) can be provided. The installation of the termination 1 can require the cutting and the removal of the metal screen and the outer sheath at the cable end portion. A part of the outer semiconductive layer 103 may remain protected by a metallic screen 104 outside and, partially, inside the termination 1. In a first lower length A of the cable end portion the outer semiconductive layer 103 can lay in a segregating tube 12 of the termination 1 according to an embodiment of the present disclosure. In a second intermediate length B, the outer semiconductive layer 103 can be cut and removed, and the insulating layer 102 can be exposed. In a third upper length C of the cable end portion the insulating layer 102 and the inner semiconducting layer can be cut and removed, and the electrically conductive core 101 can be exposed for the electrical connection to the termination 1.

The termination 1 can include a tubular insulation body 2 extending along a longitudinal axis X-X between an upper end and a lower end, and adapted to house the end portion of the cable 100. The tubular insulation body 2 can be made, e.g., of a ceramic or a polymeric material and can include a plurality of fins 5. The tubular insulation body 2 can delimit a main chamber 13 intended to be at least partially filled with an electrically insulating fluid, in particular a dielectric oil, such as silicone, or a gas, such as sulfur hexafluoride (SF6).

The termination 1 can include a stress cone 9, housed within the tubular insulation body 2, intended for fitting the cable 100 end portion therein. To this purpose, the stress cone 9 can define a through channel for the passage of the cable 100 end portion and can include a semiconductive portion 11 intended to be in contact with the cable outer semiconductive layer 103 about the interface between the first lower length A and the second intermediate length B thereof. In an embodiment, the stress cone 9 can include an insulating sleeve 10 at least partially embedding the semiconductive portion 11. The part of the semiconductive portion 11 embedded in the insulating sleeve can be the deflector 11a. In an embodiment of the present disclosure, a part 11b of the semiconductive portion 11 can extend out of the insulating sleeve 10 at the lower portion of the stress cone 9.

In an embodiment of the present disclosure, the stress cone 9 may be made of an elastomeric thermosetting material selected from, for example, silicone rubber, ethylene propylene rubber (EPR), and ethylene propylene diene rubber (EPDM). While the insulating sleeve 10 may be made of sole elastomeric thermosetting material, the semiconductive portion 11 can be made of an elastomeric thermosetting material like that of the insulating sleeve 10 added with a suitable conductive filler, e.g. carbon black.

The termination 1 can include a pass-through bottom plate 18. The lower end of the tubular insulation body 2 can be connected to the pass-through bottom plate 18 using a securing device 19. The pass-through bottom plate 18 can have a central hole for the passage of the electric cable 100. Sealing gasket(s) (not illustrated) may be present.

The termination 1 can include a segregating tube 12 coaxially extending within the tubular insulation body 2 and mechanically connecting the stress cone 9 and the pass-through bottom plate 18. In an embodiment of the present embodiment, the segregating tube 12 can surround and directly contact a lower portion of the stress cone 9. The segregating tube 12 can internally delimit a safety chamber 14, separated from the main chamber 13, which can be intended to be free from any electrically insulating fluid. The safety chamber 14 can house the lower portion of the stress cone 9 and the first lower length A of the cable end portion and can segregate them from the electrically insulating fluid filling the main chamber 13.

In an embodiment of the present disclosure, the segregating tube 12 can include, at the upper end, a first flange 6 for the mechanical connection with the stress cone 9 and, at the lower end, a second flange 7 for the mechanical connection to the pass-through bottom plate 18. In an embodiment of the present disclosure, the first flange 6 can be engaged with a counter-flange 8 connected around the lower part of the stress cone 9. In an embodiment of the present disclosure, the segregating tube 12 can be in direct contact with the insulating sleeve 10 of the stress cone 9 and/or with the semiconductive portion 11 extending out of the insulating sleeve 10 of the stress cone 9.

One or more leak-tight elements 15 (for example, an annular gasket) can be interposed between the segregating tube 12 and the stress cone 9 and/or between the segregating tube 12 and the pass-through bottom plate 18, so as to avoid the fluid to flow from the main chamber 13 into the safety chamber 14.

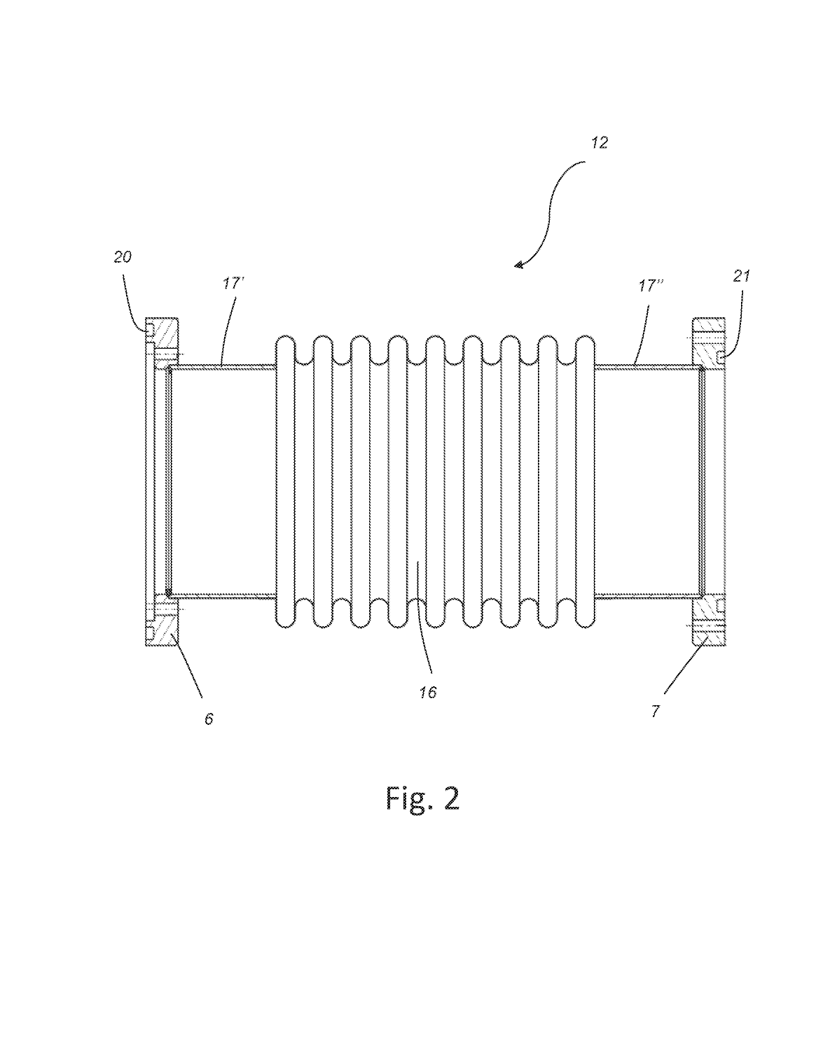

With reference to the FIG. 2, the segregating tube 12 can include at least one corrugated portion 16, making the segregating tube 12 flexible in axial direction and in lateral direction. In an embodiment of the present disclosure, the segregating tube 12 can include a single corrugated portion 16 between two opposite smooth portions 17', 17", for example in the middle thereof. The segregating tube 12 can be made in a single piece in the same or different material in different shape at the corrugated portion 16 versus the smooth portions 17', 17", such that they show different mechanical properties. In particular, the smooth portions 17', 17" can be more rigid than the corrugated portion 16. The segregating tube 12 can be made of one or more metals or metal alloys, such as diverse grades of stainless steel.

The first flange 6 and the second flange 7 can be, for example, welded to the smooth portions 17', 17". The first flange 6 can include a seat 20 for housing the above-mentioned leak tight element 15. Similarly, the second flange 7 can include a seat 21 for arranging another leak- tight element 15 to avoid leakages of the electrically insulating fluid from the tubular insulation body 2 lower end 4 outside the termination 1.

According to an embodiment of the present disclosure, a provision of a cable inside a termination can be carried out according to sequential steps, which can include: a power cable end portion (a single phase thereof) can be peeled of, sequentially, outer protective sheath, metal screen, outer semiconductive layer, insulating layer, and inner semiconductive layer to obtain a first lower length where the outer semiconductive layer is at least partially exposed, a second intermediate length where the insulating layer is exposed, and a third upper length where the conductive core is exposed; the three lengths of the power cable can be inserted in a central hole of a pass-through bottom plate; a segregating tube can have a length at least equal to the first lower length and can be inserted onto the three lengths of the power cable and fixed onto the pass-through bottom plate; a stress cone can have a length lower than the second intermediate length and can be inserted onto the three lengths of the power cable and fixed to the segregating tube; the conductive core can be connected to a conductive rod (not shown in the figures); a tubular insulating body can be inserted onto the conductive rod and the three length of the power cable, and the tubular insulating body can be fixed onto the pass-through bottom plate; and the insulating fluid can be inserted in the main chamber of the tubular insulating body.

What is claimed is:

1. A wet-type outdoor cable termination comprising:
a tubular insulation body extending along a longitudinal axis between an upper end and a lower end thereof, wherein the tubular insulation body includes a main chamber configured to be at least partially filled with an electrically insulating fluid;
a pass-through bottom plate mechanically connected to the lower end of the tubular insulation body;
a stress cone housed within the tubular insulation body, wherein the stress cone is configured to be fitted to an end portion of an electric cable; and
a segregating tube coaxially extending within the tubular insulation body between the stress cone and the pass-through bottom plate, wherein the segregating tube is surrounding and contacting at least a lower portion of the stress cone and defining a safety chamber configured to partially house the end portion of the electric cable, wherein the segregating tube comprises at least one corrugated portion configured to make the segregating tube flexible.

2. The wet-type outdoor cable termination according to claim 1, wherein the segregating tube includes at least one of a metallic material or a polymeric material.

3. The wet-type outdoor cable termination according to claim 1, wherein the segregating tube is made of a material comprising at least one metal.

4. The wet-type outdoor cable termination according to claim 3, wherein the at least one metal of the segregating tube is amagnetic.

5. The wet-type outdoor cable termination according to claim 1, wherein the segregating tube includes an electrically conductive material.

6. The wet-type outdoor cable termination according to claim 1, wherein the safety chamber is configured to be free from the electrically insulating fluid of the main chamber.

7. The wet-type outdoor cable termination according to claim 1, wherein the segregating tube comprises two opposite smooth portions such that the at least one corrugated portion is connected with and arranged between the two opposite smooth portions.

8. The wet-type outdoor cable termination according to claim 7, wherein the at least one corrugated portion and the smooth portions of the segregating tube include a same material.

9. The wet-type outdoor cable termination according to claim 7, wherein the at least one corrugated portion and the smooth portions of the segregating tube include different materials.

10. The wet-type outdoor cable termination according to claim 7, wherein the at least one corrugated portion and the smooth portions are made of a metal in different alloys or are made of different grades of stainless steel.

11. The wet-type outdoor cable termination according to claim 1, wherein the stress cone delimits a channel configured to fit the end portion of the electric cable, and wherein the stress cone comprises a semiconductive portion and an insulating sleeve partially embedding the semiconductive portion, wherein the semiconductive portion is configured to be at least partially in direct contact with an outer semiconductive layer of the end portion of the electric cable.

12. The wet-type outdoor cable termination according to claim 11, wherein the semiconductive portion is fully encircled by the insulating sleeve, or the semiconductive portion extends out of the insulating sleeve at the lower portion of the stress cone.

13. The wet-type outdoor cable termination according to claim 12, wherein the segregating tube is in direct contact with the insulating sleeve.

14. The wet-type outdoor cable termination according to claim 12, wherein the segregating tube is in direct contact with the semiconductive portion extending out of the insulating sleeve.

15. The wet-type outdoor cable termination according to claim 1, wherein the segregating tube comprises:
a first flange configured for a first mechanical connection to the stress cone; and
a second flange configured for a second mechanical connection to the pass-through bottom plate.

16. The wet-type outdoor cable termination according to claim 15, wherein the segregating tube comprises two opposite smooth portions such that the at least one corrugated portion is connected with and arranged between the two opposite smooth portions, and
wherein the first flange and the second flange are respectively welded to one of the smooth portions.

17. A wet-type outdoor cable termination comprising:
a tubular insulation body including a main chamber configured to be at least partially filled with an electrically insulating fluid;
a pass-through bottom plate mechanically connected to a lower end of the tubular insulation body;
a stress cone housed within the tubular insulation body, wherein the stress cone is configured to be fitted to an end portion of an electric cable; and
a segregating tube coaxially extending within the main chamber of the tubular insulation body, wherein the segregating tube is connected to and extending between the stress cone and the pass-through bottom plate, wherein the segregating tube is surrounding and contacting at least a lower portion of the stress cone, wherein the segregating tube comprises a corrugated portion configured to make the segregating tube flexible, wherein the segregating tube delimits a safety chamber therein from the main chamber such that the safety chamber is configured to partially house the end portion of the electric cable, and wherein the segregating tube is configured to isolate the safety chamber from the electrically insulating fluid of the main chamber.

18. The wet-type outdoor cable termination according to claim 17, wherein the segregating tube further comprises:
a first smooth portion connected to a first corrugated-portion end of the corrugated portion; and
a second smooth portion connected to a second corrugated-portion end of the corrugated portion opposite the first corrugated-portion end.

19. The wet-type outdoor cable termination according to claim 18, wherein the first smooth portion and the second smooth portion are welded to the corrugated portion,
wherein the first smooth portion and the second smooth portion include a first material, and
wherein the corrugated portion includes a second material different than the first material.

20. A method of installing a wet-type outdoor cable termination, the method comprising:
providing a peeled power cable end portion;
providing a segregating tube of the wet-type outdoor cable termination having a lower segregating-tube end fixed to a pass-through bottom plate of the wet-type outdoor cable termination, wherein the segregating tube comprises a corrugated portion configured to make the segregating tube flexible;
inserting the peeled power cable end portion through the pass-through bottom plate and the segregating tube so that the peeled power cable end portion is coaxial with the segregating tube and the pass-through bottom plate;
inserting the peeled power cable end portion through a stress cone of the wet-type outdoor cable termination so that the peeled power cable end portion is fitted with and coaxial with the stress cone;
attaching an upper segregating-tube end of the segregating tube to a lower stress-cone portion of the stress cone to form a safety chamber between a segregating-tube interior surface, a stress-cone surface of the stress cone, a cable surface of the peeled power cable end portion;
attaching a lower tubular-insulating-body end of a tubular insulating body of the wet- type outdoor cable termination to the pass-through bottom plate such that the tubular insulating body is coaxially over at least part of the peeled power cable end portion, coaxially over the stress cone, and coaxially over the segregating tube, to define a main chamber between a tubular-insulating-body interior surface of the tubular insulating body and exterior surfaces of the stress cone and the segregating tube, such that the segregating tube isolates the safety chamber from the main chamber; and
inserting an insulating fluid into the main chamber of the tubular insulating body.
